(19) United States
(12) Patent Application Publication
(10) Pub. No.: US 2010/0179853 A1
(43) Pub. Date: Jul. 15, 2010

(54) SYSTEM AND METHOD FOR PROJECT AND RESOURCE MANAGEMENT

(75) Inventors: Jose Garcia, Anderson, SC (US); Will McCuen, Taylors, SC (US)

Correspondence Address: MCNAIR LAW FIRM, P.A., P.O. BOX 447, GREENVILLE, SC, 29602-0447, US

(73) Assignee: OnSight, Inc., Greenville, SC (US)

(21) Appl. No.: 12/686,921

(22) Filed: Jan. 13, 2010

Related U.S. Application Data
(60) Provisional application No. 61/144,303, filed on Jan. 13, 2009.
(60) Provisional application No. 61/220,478, filed on Jun. 25, 2009.

(51) Int. Cl. G06Q 10/00; G06Q 30/00; G06F 17/30; G06F 15/16

(52) U.S. Cl. 705/9; 705/29; 705/32; 705/301; 707/812; 707/E17.032

(57) ABSTRACT

A resource management system having a server; a portable computing device in communication with the server having a computer readable medium; and, computer readable instructions in the compute readable medium for receiving attendance information, receiving inventory information, transmitting the attendance information and the inventory information to the server so that the server, having server computer readable instructions embodied in a server computer readable medium, can generate payroll, generate purchase order for transmission to materials suppliers, determine whether material consumption and/or cost has hit a predetermined threshold and notify a user when the predetermined thresholds have been reached.

### CLAIM OF PRIORITY

This application claims priority on U.S. Provisional Patent Application No. 61/144,303 entitled System and Method for Project and Resource Management, filed Jan. 13, 2009, and on U.S. Provisional Patent Application No. 61/220,478 entitled System and Method for Project and Resource Management, filed Jun. 25, 2009.

### FIELD OF THE INVENTION

This invention is directed to a system for managing workers and materials on a job site and includes management of selective payroll information, more specifically time and attendance data, as well as, a multitude of other user-defined measurable and tracking data including inventory information, expense information, and project progress information.

### BACKGROUND OF THE INVENTION

In the construction industry from residential homes to large commercial complexes, there are many logistical issues to be addressed. For example, tracking workers, materials, expenses, inventory and project progress is challenging given the nature of construction as the job location is remote from a central office and workers and materials travel to and from multiple locations. When engaged in multiple projects, the construction company may order materials in bulk and then split quantities between individual locations. For example, the construction company may purchase multiple pallets of bricks in an attempt to seek efficiencies in purchasing such quantity, but then split the pallets among multiple sites. Therefore, there is a need to track which materials ultimately end up at each project location and what inventory remains at each location.

During the construction process, the timing of the delivery of materials can be critical. The construction activities are dependent upon the proper materials being available for construction. It is expensive and wasteful for a construction crew to be at a job location, but have insufficient inventory of building materials to begin or complete the construction task. This situation results in lost time and money and can even result in penalties to the construction company for missing construction deadlines. Therefore, it is advantageous to schedule delivery of materials to the construction location in relation to the progress of the project so that materials are delivered to the construction location when needed. It is not advantageous to purchase the complete list of materials for a specific construction site as this can result in an unnecessary outward cash flow, inventory storage problems and inventory shrinkage problems due to theft or spoilage due to materials being exposed to the elements for too long.

Another challenge with multiple remote construction locations is that employees can be shifted between work sites. While this shifting of workers can be efficient if properly planned, the allocation of payroll among the various projects can be challenging, especially since selected payroll information, such as time and attendance data, is recorded at the remote location rather than the central office. Therefore, it would be advantageous for a system to be able to capture attendance and other payroll information at the construction location and allocate total payroll expense properly among multiple construction projects at the respective construction sites. It would also be advantageous for such a system to prevent, if not eliminate, the improper behavior of co-workers “clocking-in” for each other. This leads to inflated work times for the “clocked-in” worker.

Reimbursement expenses can be a major element of daily construction projects. The cost of fuel, replacement of tools and per diem costs are a few examples of reimbursable expenses that can total into the thousands of dollar daily for large and multi-site construction. Collecting and monitoring this information generally lags far behind the daily operation and accumulation of reimbursement expenses as the information is not immediately relayed to the central office for processing. It would be advantageous to provide a system to collect and transmit to the central office all reimbursable expenses from the job sites so that real time expense information can be provided in regard to any given construction project.

Another logistical issue with moving workers from one construction location to another is assigning the appropriate skill level to the appropriate task. The importance of this is increased when differing skilled workers are paid differing rates. One would not want to have a worker skilled in framing and with a fairly high hourly rate be assigned to debris cleaning. It would be advantageous to have a system that would record the worker and associate the worker with an assigned task in order to help utilize workers, properly assign skills to tasks, and prevent using overqualified workers for certain tasks and help reduce labor costs through properly matching skills to tasks.

During a construction project, project management is critical to insuring that the project is completed on time, within budget and with an acceptable profit for the construction company. The efficiencies of a construction project can be measured at least with tracking the number of days that it takes to complete a project and whether the materials budgeted for the project have been expended or not. Therefore, it would be advantageous to have a system that can track the number of days a project is ongoing and to compare this information with the man hours spent on the project, the cost for materials used, the cost of labor used and the time taken to complete the project.

When a lending, financial institution or investor has a financial interest in a construction project, it would be advantageous for such an entity to be able to track the progress of the project. Previously, there have been no appropriate systems to provide project information in a timely and efficient manner. Obviously, it would be an advantage, particularly when the financing entity is attempting to evaluate the financing needed or continued funding to quickly and easily know the status of a construction project.

Therefore, it is an object of this invention to provide a system that can record and forward selected payroll information, record material deliveries to a construction location, provide current reimbursable expense information, determine inventories of materials at the construction location, properly allocate labor and material across construction locations, track the progress of the construction project and the costs of the project as compared to the budgeted costs.

### DESCRIPTION OF THE DRAWINGS

This invention will more readily be understood by referencing the following drawings:

FIG. 1 is a schematic of the present invention;

FIG. 2 is a schematic and flow chart of the present invention;

FIG. 3 is a schematic of the present invention;

FIG. 4 is a flowchart of the present invention;

FIG. 5 is a schematic and flowchart of the present invention;

FIG. 6 is a schematic of the present invention;

FIG. 7 is a schematic of the present invention;

FIG. 8 is a schematic of the present invention; and,

FIG. 9 is a schematic of the present invention; and,

### DETAILED DESCRIPTION OF THE INVENTION

An object or module is a section of computer readable code embodied in a computer. The detailed description that follows may be presented in terms of program procedures executed on a computer or network of computers. These procedural descriptions are representations used by those skilled in the art to most effectively convey the substance of their work to others skilled in the art. These procedures herein described are generally a self-consistent sequence of steps leading to a desired result. These steps require physical manipulations of physical quantities such as electrical or magnetic signals capable of being stored, transferred, combined, compared, or otherwise manipulated readable medium that is designed to perform a specific task or tasks. Actual computer or executable code or computer readable code may not be contained within one file or one storage medium, but may span several computers or storage mediums. The term “host” and “server” may be hardware, software, or combination of hardware and software that provides the functionality described herein.

The present invention is described below with reference to flowchart illustrations of methods, apparatus (“systems”) and computer program products according to the invention. It will be understood that each block of a flowchart illustration can be implemented by a set of computer readable instructions or code. These computer readable instructions may be loaded onto a general-purpose computer, special purpose computer, or other programmable data processing apparatus to produce a machine such that the instructions will execute on a computer or other data processing apparatus to create a means for implementing the functions specified in the flowchart block or blocks.

These computer readable instructions may also be stored in a computer readable medium that can direct a computer or other programmable data processing apparatus to function in a particular manner, such that the instructions stored in a computer readable medium produce an article of manufacture including instruction means that implement the functions specified in the flowchart block or blocks. Computer program instructions may also be loaded onto a computer or other programmable apparatus to produce a computer executed process such that the instructions are executed on the computer or other programmable apparatus provide steps for implementing the functions specified in the flowchart block or blocks. Accordingly, elements of the flowchart support combinations of means for performing the special functions, combination of steps for performing the specified functions and program instruction means for performing the specified functions. It will be understood that each block of the flowchart illustrations can be implemented by special purpose hardware based computer systems that perform the specified functions, or steps, or combinations of special purpose hardware or computer instructions. The present invention is now described more fully herein with reference to the drawings in which the preferred embodiment of the invention is shown. This invention may, however, be embodied in many different forms and should not be construed as limited to the embodiment set forth herein. Rather, these embodiments are provided so that this disclosure will be thorough and complete and will fully convey the scope of the invention to those skilled in the art.

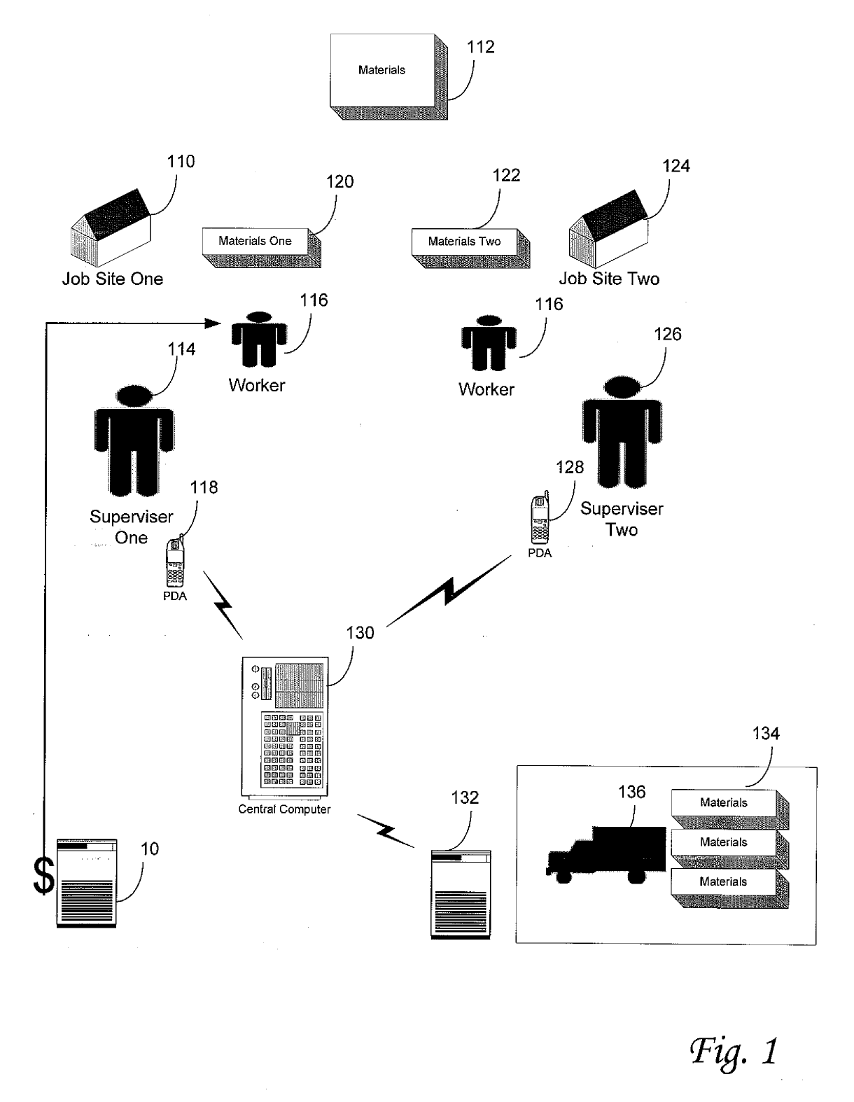

Referring now to FIG. 1, a first construction location 110 is assigned a supervisor 114. The supervisor has a portable computing device 118 that can include a cell phone, Blackberry, PDA, laptop, or other such handheld device. The portable computer device can also have GPS capabilities so that the location of the portable computer device can be known. The construction site also has various workers 116 that are assigned tasks and scheduled to work at the construction location at various times during the construction process.

Materials 112 can be ordered in quantities supporting multiple construction projects and can be segregated and delivered to multiple construction locations 110 & 124. For example, a first amount of materials 120 can be segregated into material for first construction location 110 and a second amount of materials 122 can be segmented and delivered to a second construction location 124. A second supervisor 126 can be assigned to the second construction location 124 and can have a second portable computing device 128.

The computer readable instructions can manipulate and transform data that represents the various workers, their assigned tasks, the work schedule, the construction location, and the status of the construction process. The computer readable instructions can also manipulate data that can represent quantities of materials for supporting multiple construction projects and can represent the transformation of the material packaging into segregated packaging that can be delivered to multiple construction locations.

The portable computing devices can have a housing, processor, power supply, input means, such as a keyboard, touch screen or other means, and can store computer readable instruction and computer readable information. The portable computer devices can communicate with a server 130 through communication means that include local area network, wide area network, wireless, cellular network, or other network so that the portable computer device and the central computer are in electronic communications. The portable computer device and server can communicate in real time so that data and information described herein can be transmitted generally immediately or through batch transmissions.

In one embodiment, the portable computer devices are wirelessly updated in real time from the server 130 so that changes in, for example, employees, tasks, materials and equipment are pushed out to the portable computer devices without requiring a tether or cable connection to synchronize the central computer to the portable devices. The server can have a computer readable medium that contains computer readable instructions that, when executed by the server's processor, can manipulate data representing real world physical items and quantities to reflect the status, change and other information differentials concerning the items described herein.

In a preferred embodiment, material inventories are highlighted or flagged in the server and can be transmitted to the portable computer devices when a user-defined reorder point is reached to inform workers in time to submit orders for additional materials 112.

In an optional embodiment, server 130 can also transmit and receive data and information from a material supplier's computer system 132. The material supplier's computer can receive information from the server and can generate a delivery request according to such received information for delivering materials to a particular construction location or locations. This will allow the materials 134 to be delivered through delivery means 136 to a construction location. The delivery can have the materials segregated so that while one truck delivers the materials, it can make several drops of segmented materials to multiple construction locations. Material supplier's computer 132 can also transmit delivery information, such as amount and delivery schedules, back to the server 130.

In one embodiment, server 130 can access funds information from a bank to both verify and communicate transactions with the bank. A mobile vehicle can receive paycheck information from the server and also has a mobile computer readable medium and mobile database where financial information is stored. Further, paychecks can be printed at the site location and delivered to the van. The van can then travel to a remote job site (110 & 124 in FIG. 1) and distribute the paychecks to the un-banked. Once the paychecks are distributed, the un-banked individual can present the check at the vehicle and cash the paycheck. The financial information associated with the individual stored in remote computer readable medium can be updated to reflect the cashing of the check and this information can travel back to the site location and to the bank. When a check is cashed, an image of the check and the un-banked individual's identification information can be stored in the remote computer medium so that a record of the transaction with the actual check image is accessible for future review.

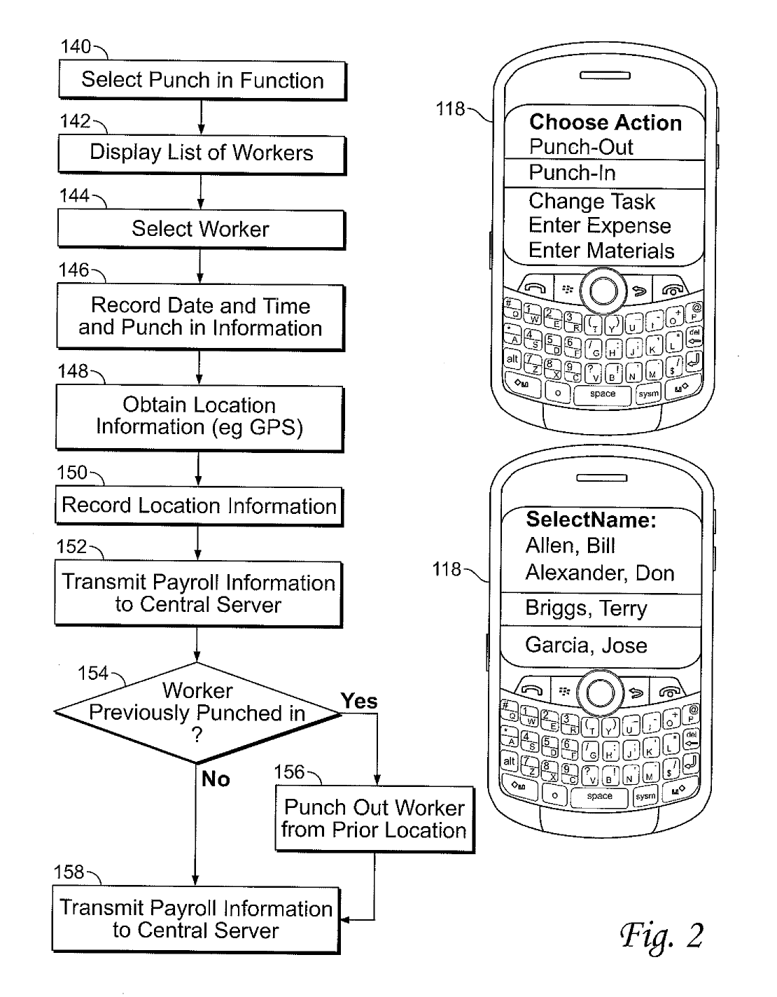

Referring to FIG. 2, one aspect of the invention directed to attendance is described in more detail. Attendance information is collected by the supervisor using the portable computing device at the job location. This allows control over the workers by the supervisor rather than allowing workers to punch in themselves. When the worker arrives at the construction location, the supervisor can select the function punch-in from the portable computing device at 140. In response, the portable computing device can display a list of workers at 142. The supervisor selects the worker at 144 and using the portable computing device's internal date and time information, the portable computer device can record when that particular worker was “punched-in” by the supervisor at 146.

The portable computing device is in communication with the server, either in a real-time or through intermittent communications for batch transmissions. When the employee is punched-in, the attendance information representing the time-in and the time-out can be stored on the portable computing device. Additionally, the location assignment information can be entered representing the particular location where the employee will begin working. Additionally, the task assignment information from the worker can be entered representing the task that the worker is assigned. When the portable computing device receives the attendance information, location assignment, and task assignment information, it can be transmitted to the server.

Once the server receives the attendance information or the location assignment information, it has computer readable instructions that can compare the attendance information or location information with information stored in a worker database which is in turn shared on the server's computer readable medium. Based upon predetermined criteria, a worker alert can be generated and transmitted to the portable computing device so that the supervisor can have virtually instant feedback concerning the hours worked by the worker, the job site where the worker works, and the task assigned to the worker.

For example, if the worker's time-in is entered, this time can be sent to the server, the server's computer readable instructions can determine from the worker database if the worker risks working overtime or if the worker is already in overtime. If so, a worker alert is generated and sent to the portable computing device informing the supervisor that the worker risks or is already in overtime. This allows the supervisor to balance worker's hours and helps prevent the situation where one working has twenty (20) hours for a week, while the other has sixty (60).

Further, the task that is assigned to the worker is entered, it can be sent to the server that can compare the assigned task with the worker database to determine if the worker is assigned a task above or below the worker's skill, above or below the worker's pay grade or if the task is being assigned in duplication. If any of these conditions are met, a worker alert can be generated and sent to the portable computing device.

Further, the job location information can be received from the portable computing device and sent to the server. The server can generate a worker alert if the job location information results in a determination that there are too many or too few workers at a specific job location, there are too many or too few workers with a particular skill set at a particular location, or there are “missing” workers or other issues that can result in a worker alert being generated.

Further, the location information can include geographic location information allowing the server to track which state, or other politically defined area, the worker performed his tasks. This allows the worker database to send information to a payroll system to allow the payroll system to determine appropriate taxes for the work performed by the worker.

Further, the worker database can include information representing the maximum expenses that the worker can request. Such maximum can be reset for a pay period, week, month, or other time span. If expense request information received by the portable computing device and transmitted to the server causes the server to determine the expense request will exceed the maximum allowed, a worker alert can be generated.

In one embodiment, the portable computer device also contains GPS or other location identification technology. When the Worker is “punched in” on the computer portable device, the location of the portable computer device is obtained, for example, through GPS system at 148. The location information is then associated with the worker so that not only is it recorded the date and time the worker was punched in, but also the location where the worker was punched in at 150.

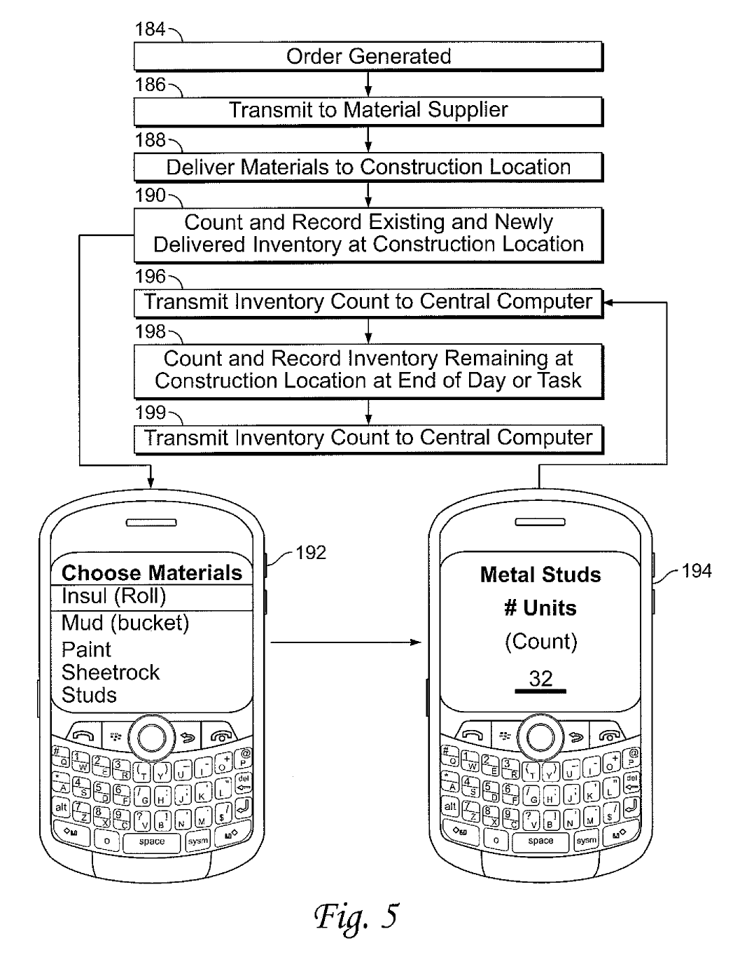

In one embodiment, the portable computer device communicates with central computer 130 (FIG. 5) in real time. In this embodiment, the portable computer device transmits the payroll information, including worker identification information, such as name, employee number, or other identifying data, the date and time the worker was punched in and the location where the worker punched in. This information is then stored on the server. When the worker is punched in and the server receives the payroll information, the server can determine whether that particular worker has previously been punched in that day at another location at 154. If so, the server can automatically “punch out” that worker from the prior location so that the worker is not recorded for having been working at two locations at 156. The information can then be transmitted to a payroll server for processing at 158.

In one embodiment, the portable computer device is in batch communications with the server and payroll information is transmitted in batch mode at the end of the day or during some other time. When the server receives the payroll information from all of the portable computer devices, the server can then determine, according the payroll information, whether the worker was punched in at two locations (e.g., the supervisor forgot to punch the worker out of the prior location) at 154 and can adjust the payroll information accordingly prior to sending the payroll information for processing.

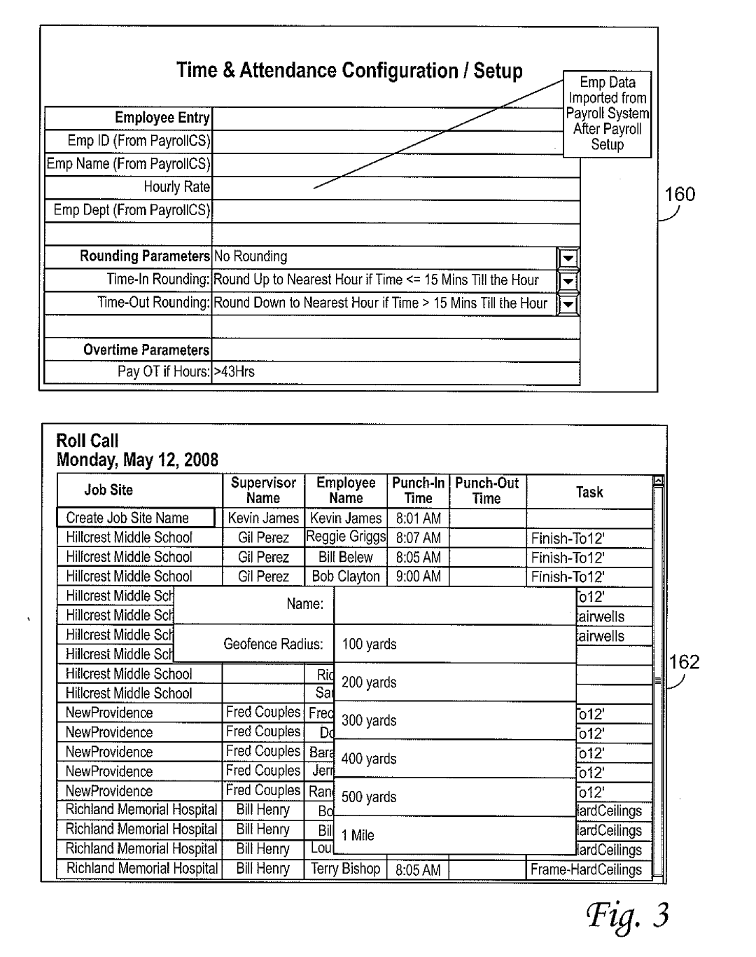

Referring to FIG. 3, screen 160 is shown that is used for configuration of payroll information. In one embodiment, this screen allows the user to establish such information as: the employee ID, employee name, hourly rate for the employee, time in rounding information, time out rounding information and overtime threshold. In one embodiment, the payroll information can be downloaded from the server 130. In one embodiment, the payroll information can be retrieved from the payroll server by the server. In one embodiment, the payroll information is accessed by the portable computer device from the server. In one embodiment, the payroll information is stored on the portable computer device.

In one embodiment, the system allows for punching in teams of workers rather than having to punch in individuals in a linear fashion. Workers can be associated with teams, such as an insulation team or framing team, and when the team is punched in, each of the individual workers would be punched in.

As can be seen from screen 162 of FIG. 3, a geofence can be designated for each of the construction locations. A geofence is a predetermined area surrounding a construction location and preferably containing the construction location. When a worker is punched in, the portable computer device can retrieve location information and using the geofence information to determine to which construction location the worker has been punched in. In one embodiment, the geofence is defined in increments that include 100, 200, 300, 400, 500 yards or one mile. Having this information allows the server to allocate the labor costs associated with this worker to the specific construction project associated with that construction location.

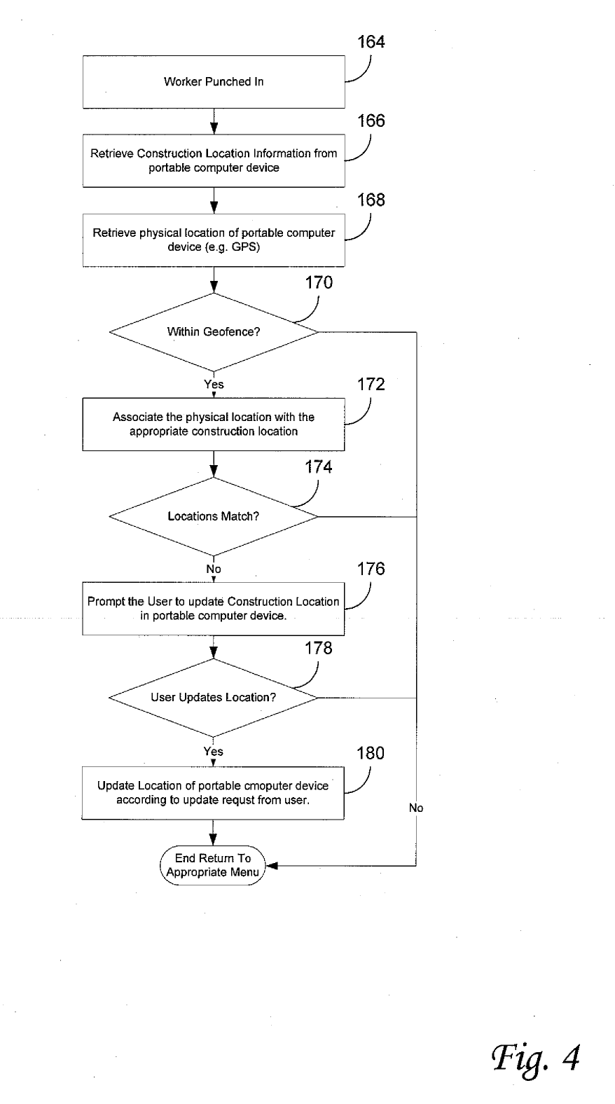

Referring to FIG. 4, the worker is punched in at 164. The construction location information that is presently stored in the portable computer device, which could be null, is retrieved at 166. The physical location of the portable computer device is retrieved through a location system such as GPS at 168. A determination is made as to whether the physical location of the portable computer device is within a geofence of a construction location at 170. If the answer is yes, the physical location of the portable computer device is associated with the appropriate construction location at 172. A determination is then made as to whether the construction location associated with the physical location matches the construction location retrieved from the portable computer device at 174. If the construction location associated with the physical location matches the construction location retrieved from the portable computer device, no action is taken. However, if it does not, the user is prompted to update the construction location stored in the portable computer device at 176. If the user decides to update the construction location information at 178, the information is updated at 180.

Since the portable computer device can be associated with a particular construction location, the amount paid to the worker, based upon the information collected by portable computer device, can be allocated to that particular construction location.

This invention also provides a benefit in that it can be used to track materials at a construction location. Construction materials are represented by data contained in a computer readable medium of the server that, when processed by the processor, can provide the quantities and location of construction materials at each construction location, individually or collectively. Materials ordered by a construction company can be ordered in bulk as shown in FIG. 1, 134. Therefore, efficiencies are realized both in purchase price and shipping. While the materials can initially be shipped by one transport vehicle, the vehicle can stop at a multitude of construction locations and deliver a portion of the original order to each location. The instructions for the order and shipping are received from a server 130 and sent to a supplier computer 132. The materials supplier can then travel to construction location 110 and deliver a portion of the ordered materials 120. The materials are then used for the particular job site. When the server 130 transmits an order request to the vendor server, the server then knows how much of a material was ordered. Data contained on the server's computer readable medium represents the order for materials. Once the materials are dropped off and used during the day, the supervisor can use the portable computing device and take inventory in order to determine what inventory is on hand for that construction location. With this periodic inventory being taken at the job site, the inventory information can be transmitted to the server.

Referring to FIG. 5, the process is explained in further detail. An order is generated at 184 that contains the quantity and type of material ordered. In one embodiment, the order is generated when the computer readable instructions determine that there is a need for an order of materials for a specific construction location.

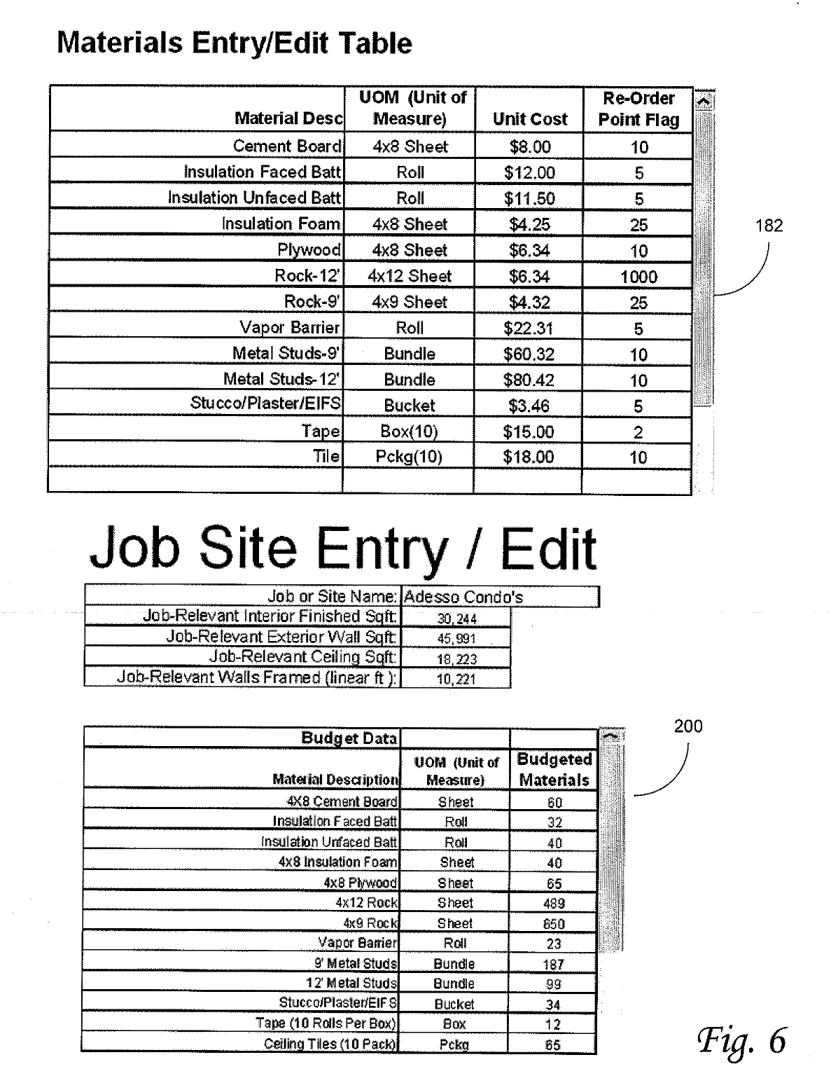

Referring to FIG. 6, a screen 182 is shown where the reorder point flag is displayed, which provides an automatic notification that additional materials need to be ordered. The computer readable instructions can accept a user defined reorder point for each type of material entered. When the inventory level reaches the reorder point, the user can be prompted to generate an order to a materials supplier to reorder more of that material. In one embodiment, the order can be automatically generated and transmitted to the materials supplier.

Referring to FIG. 5, when the order is generated at 184, the order is transmitted to the material supplier via the server 130 and the material supplier server 132 at step 186. At step 188, the materials are delivered to one or more construction locations via delivery means 136. Once the materials have arrived, the supervisor 114 counts the materials and enters the quantity delivered and/or the existing inventory and newly delivered inventory into the portable computing device 118. The portable computing device allows the supervisor to select the type of material being delivered from a list displayed by the portable computing device at 192. At 194 the supervisor enters the number of units of the selected type of material. The inventory count information can then be downloaded to the server at 196 and the inventory of materials, according the quantity ordered and the inventory count information, be updated to provide the quantity of materials that were delivered to the construction location and the quantity of materials that were counted at the construction site. At the end of each day, or as a specific project task is completed the supervisor enters the number of units of each material that are remaining at the construction location at step 198 and the existing inventory is then transmitted to the server so that the amount of materials at each construction location can be tracked.

Therefore, the invention can collect, store, and transmit to a central location information such as worker attendance and inventory that can be captured at the construction location, In a further embodiment, in addition to materials inventory, the system can be used to measure and track equipment meter reading or vehicle mileage, or any other similar user defined measurable data that can be collected.

In one embodiment, the invention can be used for creating a budget for a construction project. The materials that are needed can be entered into the central computer through an input screen shown at 200 (FIG. 6). Through using the budgeted materials information and the ordered and inventory count information, the amount of materials used compared to the budget on materials can be determined.

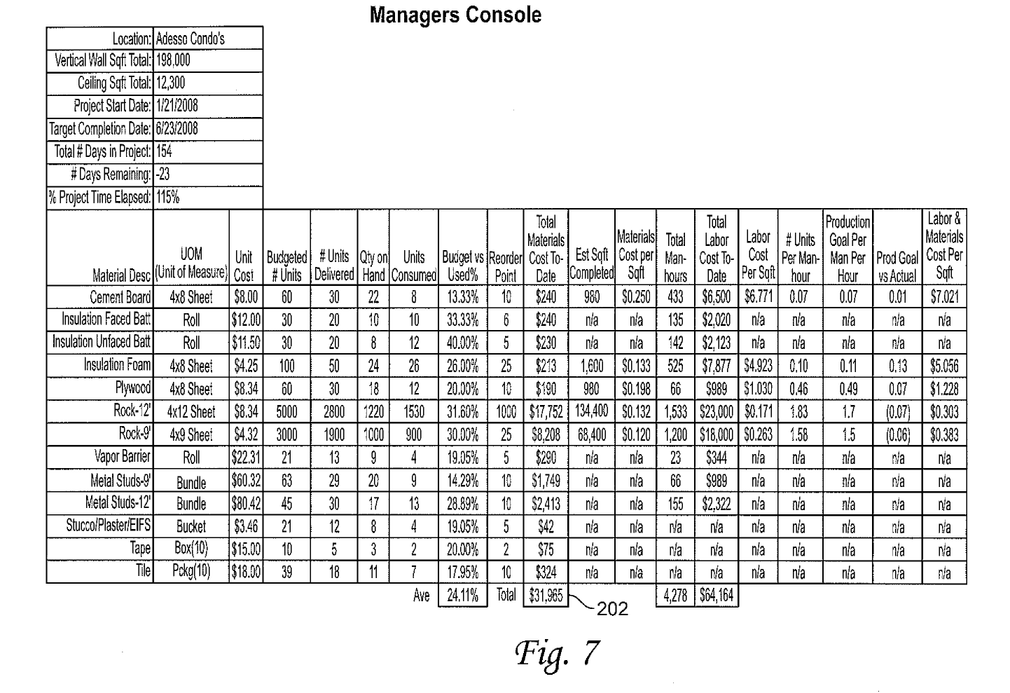

Referring to FIG. 7, a screen that can be used for reviewing the status of a project is shown at 202. The screen can provide information to a user that includes a description of the material. The unit of measure and the unit cost can be shown associated with the material. The budgeted amount of the material for the specific construction project can also be shown. The number of units that were delivered to the construction location, the quantity on hand at the construction location, the number of units consumed at the construction site and the variance between the budgeted amount and the used amount can be displayed. The reorder point can be shown with indications when the reorder point has been reached. The total cost of the material can be shown. An estimate of the number of materials needed and the number of hours to complete the project can be shown. The total labor costs to date can be shown as well as several methods for comparing labor costs with square feet, production goals, and the variances between the budget and the actual costs. This allows a user to quickly determine whether there is a problem with the project when compared to the budget.

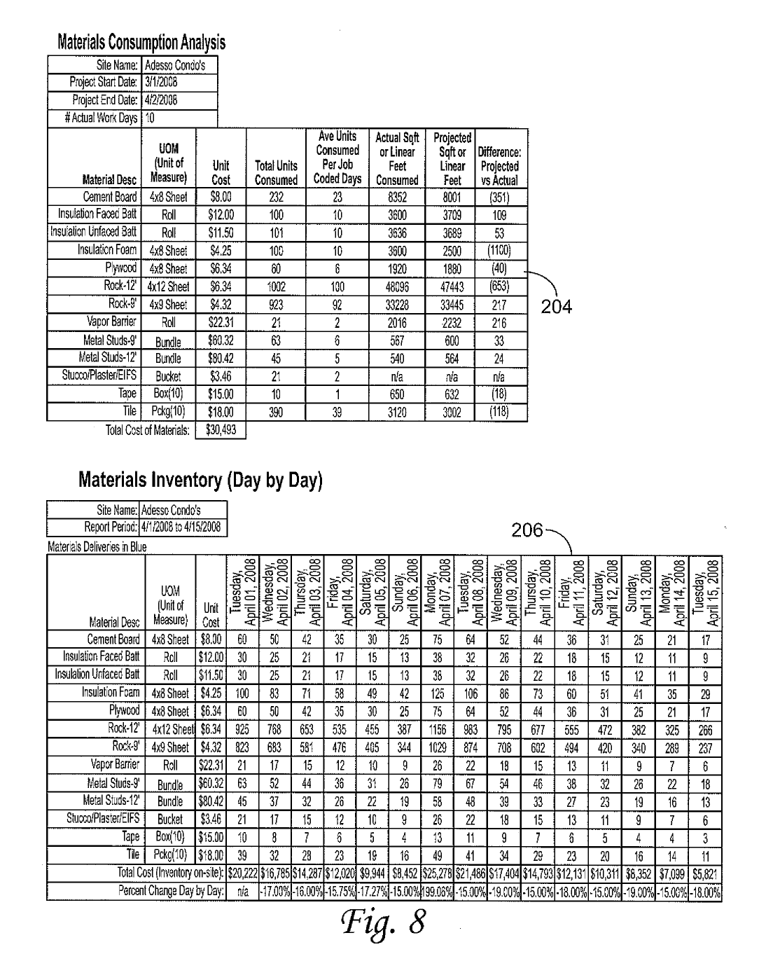

Referring to FIG. 8, additional information provided by the invention is shown. A materials consumption report 204 is shown for a particular construction project. From this report, it can be seen that for each material on the report, the total units consumed for each construction project day can be determined and the variance between the actual and the projected quantities used can be shown. By having the actual quantity of material consumed taken from the inventory information and comparing it with the projected or budgeted materials used, the variance between actual and projected consumption can be determined. Materials inventory can be displayed on a periodic basis such as day-to-day at 206. An indicator, such as turning the numbers another color, can indicate when deliveries were made to the construction location so that it provides information as to why inventory of materials rises.

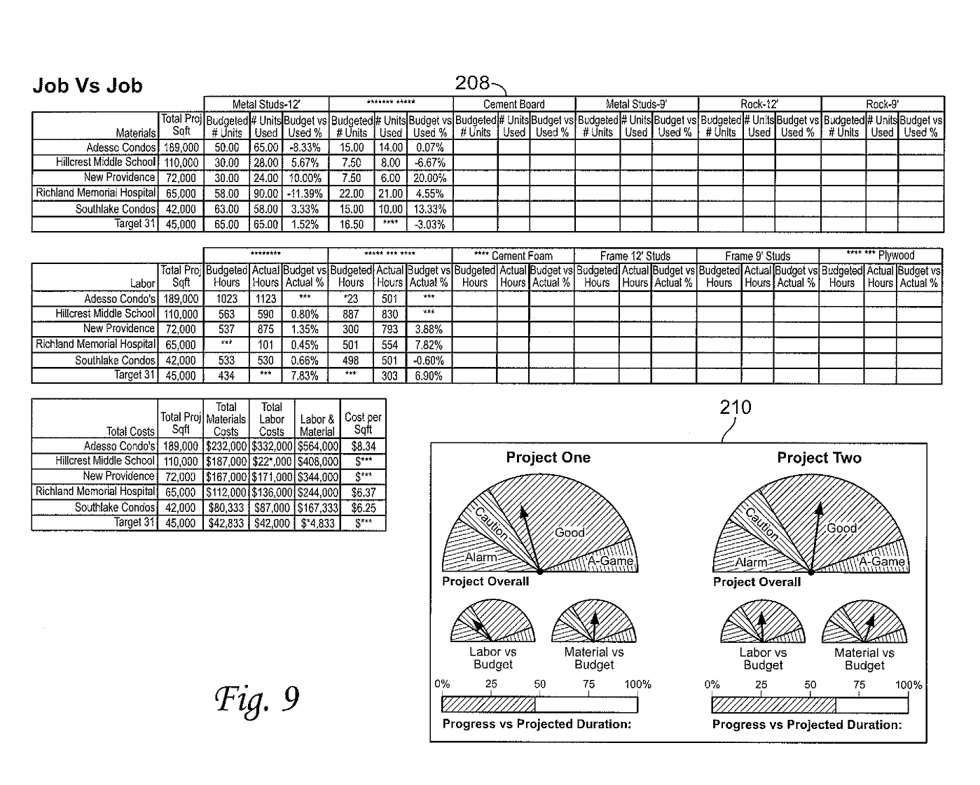

Referring to FIG. 9, report 208 can show comparison between projects. It should also be noted that graphical representation such as those shown as 210 can be used to report the status of a particular construction project. Additionally, the information concerning materials, job progress, labor and costs can be tracked and when predetermined thresholds are reached, notification can be sent to users of the invention from the central computer. Notification can take the form of emails, pre-recorded phone calls, etc.

While a preferred embodiment of the invention has been described using specific terms, such description is for illustrative purposes only, and it is to be understood that changes and variations may be made without departing from the spirit or scope of the following claims.

What is claimed is:

1. A resource management system comprising:
a portable computing device having a housing carrying a computer portable readable medium, processor, and power supply, transmitter, receiver, portable input means and portable display;
a server having a server computer readable medium, processor, power supply, transmitter, receiver, server input means and server display in communication with said portable computing device;
a worker database stored on said server computer readable medium having worker information representing the time the worker has worked for the current pay period, the tasks the worker is approved to perform, and the job location information representing where the worker has worked;
a set of portable computer readable instructions stored on said portable computer readable medium that, when executed by said processor, carried by said portable computing device, perform the steps of receiving attendance information through said portable input means, receiving task assignment information through said portable input means, receiving location assignment information through said portable input means, transmitting said attendance information, task assignment information, and said location assignment information to said server;
a set of server computer readable instructions stored on said server computer readable medium that, when executed by said processor of said server, perform the steps of receiving attendance information from said portable computing device, incorporating said attendance information into said worker database, retrieving worker information from said worker database, determining if a worker alert should be generating according to said attendance information and said worker information, generating said worker alert if said worker alert should be generated and transmitting said worker alert to said portable computing device.

2. The system of claim 1 wherein said set of server computer readable instructions include instructions for receiving task assignment information from said portable computing device, incorporating said task assignment information into said worker database, and determining if a worker alert should be generated according to said task assignment information and said worker information.

3. The system of claim 1 wherein said set of server computer readable instructions include instructions for receiving job location information from said portable computing device, incorporating said location information into said worker database, and determining if a worker alert should be generated according to said job location information and said worker information.

4. The system of claim 1 including:
geographic location information included in said worker information representing the state where the worker performed the worker's tasks;
said set of server computer readable instructions include instructions for retrieving location assignment information from said portable computing device, incorporating said assignment information into said worker database, transmitting said worker information to an accounting system so that the worker can be paid according to said worker information.

5. The system of claim 1 including:
expense allowance information included in aid worker database representing the maximum expenses that can be incurred by the worker;
said set of portable computer readable instructions include instructions for receiving expense request information, representing the worker's expense reimbursement request, through said input means and transmitting said request information to said server;
said set of server computer readable instructions include instructions for receiving said expense request information from said portable computing device, incorporating said expense request information in said worker database, and determining if a worker alert should be generated according to said expense allowance and said worker database.

6. The system of claim 1 wherein:
said worker information represents the employee identification, the employee's supervisor's identification; and,
said server computer readable instructions include instructions for retrieving said worker's information from said worker database and displaying to the user information from the group of employee identification, hourly rate, punch-in time, punch-out time, assigned task, assigned location, pay period hours worked, overtime hours, supervisor's identification, hours worked for the job, labor costs to date, labor costs per square foot and the difference between actual hours worked and budgeted hours.

7. The invention of claim 1 wherein said set of portable computer readable instructions includes instructions for receiving material site quantity information through said input means and transmitting said material site quantity information to said server.

8. The system of claim 7 including:
a materials database stored on said server computer readable medium having materials information representing the type of material, the cost of the material, the budgeted units, the material location, and the material quantity; and,
said set of server computer readable instructions include instructions for receiving said material site quantity information from said input means, incorporating said materials site quantity information in said materials database; and,
displaying said material information to a user of said server through said server's display.

9. The system of claim 8 wherein said server computer readable instructions include instructions for receiving a materials transfer request representing the desire to transfer materials from a first location to a second location, transmitting said transfer request to a portable computing device associated with the first location and a portable computing device associated with a second location.

10. The system of claim 8 wherein said server computer readable instructions include instructions for retrieving said materials information from said materials database and displaying to the user information from the group of material description, unit of measure, unit cost, total units consumed, average units consumed per job, square feet consumed, linear feet consumed, projected square feet, projected linear feet, variance between actual and budgeted, quantity on hand, reorder point, materials cost to date and materials cost per square foot.

11. The system of claim 8 wherein:
said server is in communication with a vendor server; and,
said set of server computer readable instructions include instructions for generating a materials order representing the type, quantity and delivery location of the material desired, transmitting said materials order to the vendor server, incorporating said material order in said materials database on said server.

12. The system of claim 11 including:
a re-order quantity included in said materials database representing the minimum quantity of a material to keep in inventory; and,
said set of server computer readable instructions include instructions for generating a materials alert when a determination is made that said material quantity falls below said re-order quantity, and displaying said materials alert to the user through the server's display.

13. The system of claim 12 wherein said set of server computer readable instructions include instructions for generating said materials order when said determination is made that said material quantity falls below said re-order quantity.

14. The system of claim 6 wherein said server computer readable instructions include instructions for displaying said information graphically.

15. The system of claim 10 wherein said server computer readable instructions include instructions for displaying said information graphically.

16. A resource management system comprising:
a server having a server computer readable medium, processor, power supply, input means, display and network connection means for communicating with a portable computing device;
a worker database stored on said server computer readable medium having worker information representing the time the worker has worked for the current pay period, tasks the worker is approved to perform, and the job location information representing where the worker has worked; and,
a set of server computer readable instructions stored on said server computer readable medium that, when executed by said processor of said server, perform the steps of receiving attendance information from said portable computing device, incorporating said attendance information into said worker database, retrieving worker information from said worker database, determining if a worker alert should be generated according to said attendance information and said worker information, generating said worker alert if said worker alert should be generated and transmitting said worker alert to said portable computing device.

17. The system of claim 16 wherein said set of server computer readable instructions include instructions for receiving task assignment information from said portable computing device, incorporating said task assignment information into said worker database, and determining if a worker alert should be generated according to said task assignment information and said worker information.

18. The system of claim 16 wherein said set of server computer readable instructions include instructions for receiving job location information from said portable computing device, incorporating said location information into said worker database, and determining if a worker alert should be generated according to said job location information and said worker information.

19. The system of claim 16 including:
geographic location information included in said worker information representing the state where the worker performed the worker's tasks;
said set of server computer readable instructions include instructions for retrieving location assignment information from said portable computing device, incorporating said assignment information into said worker database, transmitting said worker information to an accounting system so that the worker can be paid according to said worker information.

20. The system of claim 16 wherein:
said worker information represents the employee identification, the employee's supervisor's identification; and,
said server computer readable instructions include instructions for retrieving said worker's information from said worker database and displaying to the user information from the group of employee identification, hourly rate, punch-in time, punch-out time, assigned task, assigned location, pay period hours worked, overtime hours, supervisor's identification, hours worked for the job, labor costs to date, labor costs per square foot and the difference between actual hours worked and budgeted hours.

21. The system of claim 20 wherein said server computer readable instructions include instructions for displaying said information graphically.

22. The invention of claim 16 wherein said set of portable computer readable instructions includes instructions for receiving material site quantity information through said input means and transmitting said material site quantity information to said server.

23. The system of claim 22 including:
a materials database stored on said server computer readable medium having materials information representing the type of material, the cost of the material, the budgeted units, the material location, and the material quantity; and,
said set of server computer readable instructions include instructions for receiving said material site quantity information from said input means, incorporating said materials site quantity information in said materials database; and,
displaying said material information to a user of said server through said server's display.

24. The system of claim 23 wherein said server computer readable instructions include instructions for receiving a materials transfer request representing the desire to transfer materials from a first location to a second location, transmitting said transfer request to a portable computing device associated with the first location and a portable computing device associated with a second location.

25. The system of claim 23 wherein said server computer readable instructions include instructions for retrieving said materials information from said materials database and displaying to the user information from the group of material description, unit of measure, unit cost, total units consumed, average units consumed per job, square feet consumed, linear feet consumed, projected square feet, projected linear feet, variance between actual and budgeted, quantity on hand, reorder point, materials cost to date and materials cost per square foot.

26. The system of claim 23 wherein:
said server is in communication with a vendor server; and,
said set of server computer readable instructions include instructions for generating a materials order representing the type, quantity and delivery location of the material desired, transmitting said materials order to the vendor server, incorporating said material order in said materials database on said server.

27. The system of claim 23 including:
a re-order quantity included in said materials database representing the minimum quantity of a material to keep in inventory; and,
said set of server computer readable instructions include instructions for generating a materials alert when a determination is made that said material quantity falls below said re-order quantity, and displaying said materials alert to the user through the server's display.

28. The system of claim 12 wherein said set of server computer readable instructions include instructions for generating said materials order when said determination is made that said material quantity falls below said re-order quantity.
